(19) United States
(12) Patent Application Publication
(10) Pub. No.: US 2026/0295825 A1
(43) Pub. Date: Oct. 1, 2026

(54) INFORMATION PROCESSING METHOD, INFORMATION PROCESSING APPARATUS, ROBOT, METHOD FOR MANUFACTURING ARTICLE, AND RECORDING MEDIUM

(71) Applicant: CANON KABUSHIKI KAISHA, Tokyo (JP)

(72) Inventor: KEI SUGIHARA, Kanagawa (JP)

(21) Appl. No.: 19/566,082

(22) Filed: Mar. 13, 2026

(30) Foreign Application Priority Data
Mar. 28, 2025 (JP) 2025-055354

(51) Int. Cl. B25J 9/16

(52) U.S. Cl. CPC B25J 9/1633; B25J 9/1674

(57) ABSTRACT

An information processing method for generating a command value to be used in controlling a force of a robot is provided, the information processing method including acquiring a first value and a second value for the command value, and receiving, from a user, a manner of changing the command value from the first value to the second value.

### BACKGROUND

### Field of the Technology

The present disclosure relates to an information processing method, an information processing apparatus, a robot, a method for manufacturing an article, and a recording medium.

### Description of the Related Art

In automation of production processes using a robot, the robot is caused to perform component assembly work by controlling the force of the robot. In order to automate the assembly work using force control, the user needs to set a force command value corresponding to the assembly work in advance in an information processing apparatus such as a control device.

JP 2017-164822 A discloses a robot system configured to enable a user to set a force control parameter including a command value in a control device.

For controlling the force of the robot, a complicated operation has been required, and there has been a demand for a technique capable of easily setting information to be used in generating a command value corresponding to the complicated operation.

### SUMMARY

The present disclosure provides a technique advantageous in setting information to be used in generating a command value.

According to a first aspect of the present disclosure, an information processing method for generating a command value to be used in controlling a force of a robot is provided, the information processing method including acquiring a first value and a second value for the command value, and receiving, from a user, a manner of changing the command value from the first value to the second value.

According to a second aspect of the present disclosure, an information processing apparatus includes a processor configured to generate a command value to be used in controlling a force of a robot, the processor being configured to acquire a first value and a second value for the command value, and to receive, from a user, a manner of changing the command value from the first value to the second value.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of a robot system according to the first embodiment.

FIG. 2 is a block diagram illustrating a configuration of the robot system according to the first embodiment.

FIG. 3A is an explanatory diagram of press-fitting work according to the first embodiment.

FIG. 3B is an explanatory diagram of the press-fitting work according to the first embodiment.

FIG. 3C is an explanatory diagram of the press-fitting work according to the first embodiment.

FIG. 4 is a flowchart illustrating the press-fitting work according to the first embodiment.

FIG. 5A is an explanatory diagram illustrating a change of a force command value over time according to the first embodiment.

FIG. 5B is an explanatory diagram illustrating a change of a force command value over time according to the first embodiment.

FIG. 6 is an explanatory diagram of a setting screen according to the first embodiment.

FIG. 7 is an explanatory diagram of a setting screen according to the first embodiment.

FIG. 8 is an explanatory diagram of a setting screen according to the first embodiment.

FIG. 9 is an explanatory diagram of a main screen according to the second embodiment.

FIG. 10 is an explanatory diagram of an operation handle according to the second embodiment.

FIG. 11 is an explanatory diagram of a main screen according to the second embodiment.

FIG. 12 is an explanatory diagram of a main screen according to the second embodiment.

FIG. 13 is an explanatory diagram of a display screen according to the second embodiment.

### DESCRIPTION OF THE EMBODIMENTS

When executing work during which a large load is applied to a robot by controlling the force of the robot, such as press-fitting work of press-fitting a workpiece into another workpiece, a command value (force command value) related to the force control is gradually increased in order to prevent overcurrent in a motor that drives a joint of the robot and damage to the robot. Therefore, the present disclosure provides a technique by which a user can easily set a complicated force command value such as a force command value that gradually increases or decreases.

Hereinafter, embodiments of the present disclosure will be described in detail with reference to the drawings. Configurations of the embodiments to be described below, for example, detailed configurations, can be appropriately modified for implementation by those skilled in the art without departing from the gist of the present disclosure.

Note that, in the drawings referred to in the following description of embodiments, elements denoted by the same reference signs have the same functions unless otherwise specified. In the drawings, in a case where a plurality of identical elements are arranged, the reference signs and explanations thereof may be omitted. In addition, since the drawings may be schematically represented for convenience of illustration and explanation, shapes, sizes, arrangements, and the like of elements illustrated in the drawings may not exactly coincide with those of the elements illustrated in other drawings or to those of actual objects.

### First Embodiment

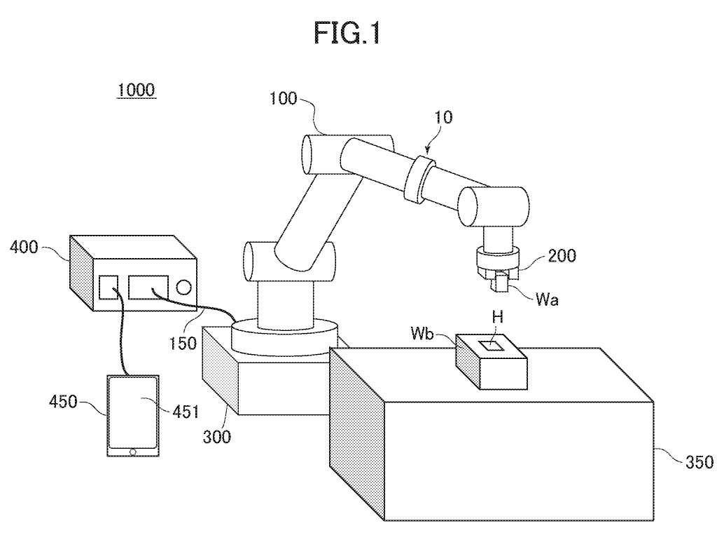

FIG. 1 is a schematic diagram of a robot system 1000 according to the first embodiment. The robot system 1000 includes a robot 10, a base 300, a mount 350, a control device 400, and an operation panel 450. The control device 400 is connected to the robot 10 by wiring 150, and is configured to control the robot 10 through the wiring 150. The robot 10 is, for example, an industrial robot.

The robot 10 includes a robot arm 100 and an end effector 200. In the first embodiment, the robot 10 holds a workpiece Wa, and performs press-fitting work to press-fit the workpiece Wa into a workpiece Wb. The workpiece Wa is an example of a first workpiece, and the workpiece Wb is an example of a second workpiece. When the robot 10 performs production work including the press-fitting work, a product, which is an example of an article, is manufactured. The article may be a final product or an intermediate product.

The robot arm 100 is disposed on the base 300. A base end of the robot arm 100 is fixed to the base 300. The end effector 200 is disposed at a distal end of the robot arm 100. The robot arm 100 is, for example, a vertically articulated robot arm. The robot arm 100 has, for example, six joints.

The end effector 200 is configured to hold the workpiece Wa as a target object. In the first embodiment, a case where the end effector 200 is a robot hand including two finger portions will be described as an example, but the configuration of the end effector 200 is not limited thereto. For example, the end effector 200 may be a vacuum gripper that holds the workpiece Wa by sucking the workpiece Wa.

The workpiece Wb is placed at a predetermined position on the mount 350. The workpiece Wb is fixed onto the mount 350 so that the workpiece Wb does not move while the workpiece Wa is press-fitted into the workpiece Wb. The workpiece Wb has a recess H. The control device 400 controls the robot 10 to cause the robot 10 to hold the workpiece Wa, and cause the robot 10 to perform an operation of bringing the workpiece Wa held by the robot 10 into contact with the recess H of the workpiece Wb and then pushing the workpiece Wa into the recess H of the workpiece Wb. The work including this series of operations is referred to as press-fitting work.

The operation panel 450 is connected to the control device 400. The operation panel 450 may be a teaching pendant or the like. The operation panel 450 includes a display 451 serving as a display unit. The display 451 is a touch panel display, and also functions as an input unit that receives a user's input. Various parameters for causing the control device 400 to generate a force command value are input by the user using the operation panel 450.

Note that the display unit is not limited to the display 451 included in the operation panel 450, and may be a display separate from the operation panel 450. Furthermore, a case where the device that receives a user's input is the display 451 will be described, but the device that receives a user's input is not limited thereto, and may be an input device different from the display 451, such as a mouse, a keyboard, or a touch pad.

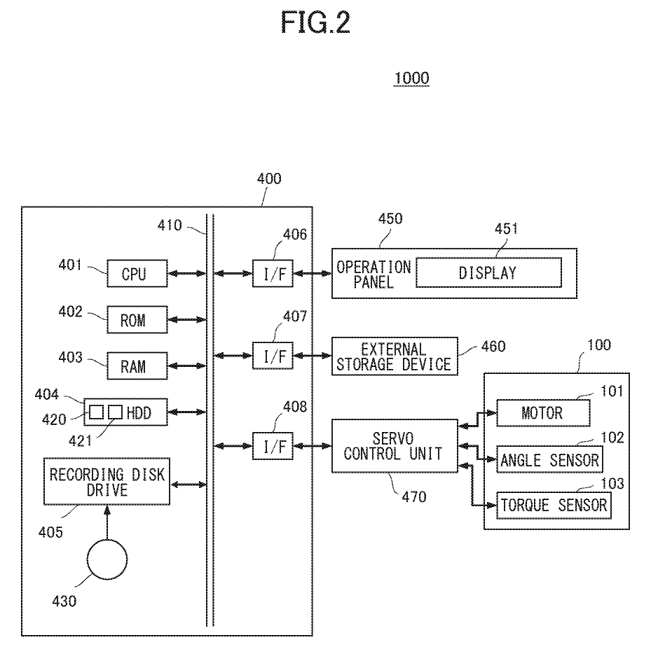

FIG. 2 is a block diagram illustrating a configuration of the robot system 1000 according to the first embodiment. The robot arm 100 is a six-axis articulated robot, and includes a motor 101, an angle sensor 102, and a torque sensor 103 arranged on each axis (that is, each joint).

The control device 400 is an example of an information processing apparatus, and is constituted by a computer. The control device 400 includes a central processing unit (CPU) 401 serving as a processor. In addition, the control device 400 includes storage devices such as a read only memory (ROM) 402, a random access memory (RAM) 403, and a hard disk drive (HDD) 404 as examples of storage units.

In addition, the control device 400 includes a recording disk drive 405 and a plurality of input/output interfaces (I/Fs) 406 to 408. The ROM 402, the RAM 403, the HDD 404, the recording disk drive 405, and the input/output interfaces 406 to 408 are connected to the CPU 401 via a bus 410.

The ROM 402 stores a basic program read by the CPU 401 when the computer is started. The RAM 403 is a storage device that temporarily stores various types of data such as arithmetic processing results of the CPU 401. The HDD 404 is a storage device that stores arithmetic processing results of the CPU 401, various types of data acquired from the outside, etc. A program 420 for causing the CPU 401 to execute arithmetic processing and control processing is recorded in the HDD 404. The CPU 401 controls the robot 10 based on the program 420 recorded (stored) in the HDD 404.

The recording disk drive 405 can read various types of data, programs, and the like recorded in the recording disk 430. The operation panel 450 is connected to the input/output interface 406. The CPU 401 acquires input data (input information) including a setting file for use in generating a force command value from the operation panel 450 via the input/output interface 406 and the bus 410. The input data is stored in the HDD 404 as setting information 421. The CPU 401 generates a force command value using the setting information 421 and commands the servo control unit 470 with the force command value, thereby controlling the force of the robot 10 via the servo control unit 470. The input/output interface 407 is configured to allow an external storage device 460, which is a storage unit such as a rewritable nonvolatile memory or an external HDD, to be connected thereto.

The servo control unit 470 is connected to the input/output interface 408. The motor 101, the angle sensor 102, and the torque sensor 103 for each joint of the robot arm 100 are connected to the servo control unit 470. The motor 101 is, for example, a brushless DC motor or an AC motor, and rotationally drives a corresponding joint among the plurality of joints. The angle sensor 102 is, for example, a rotary encoder, is provided in the motor 101, and is configured to be able to detect a rotation angle of the motor 101. The torque sensor 103 is provided in a corresponding joint among the plurality of joints, and is configured to be able to detect a torque acting on the corresponding joint.

The CPU 401 can acquire angle information from the angle sensor 102 via the servo control unit 470, the input/output interface 408, and the bus 410, and can acquire torque information (torque value) from the torque sensor 103. The servo control unit 470 may divide the angle of the motor 101 detected using the angle sensor 102 by a speed reduction ratio of a speed reducer (not illustrated), convert the result into angle information of the corresponding joint, and transmit the angle information to the CPU 401. The CPU 401 outputs a signal indicating a command value corresponding to each joint to the servo control unit 470 via the bus 410 and the input/output interface 408 at every predetermined time interval (e.g., 1 ms). The information from the angle sensor 102 and the information from the torque sensor 103 are used for force control, for example, PID control.

The HDD 404 is also a non-transitory computer-readable recording medium. In the present embodiment, the program 420 is stored in the HDD 404, but the storage of the program 420 is not limited thereto. The program 420 may be recorded in any recording medium as long as it is a non-transitory computer-readable recording medium. For example, a flexible disk, a hard disk, an optical disk, a magneto-optical disk, a magnetic tape, or a nonvolatile memory can be used as the recording medium for supplying the program 420. The optical disk is, for example, a disk medium such as a Blu-ray disk, a DVD, or a CD. The nonvolatile memory is, for example, a storage device such as a USB memory, a memory card, a ROM, or an SSD.

Furthermore, the control device 400 may be configured to be able to communicate with an external device via a network, and the program 420 may be downloaded from the external device via the network.

The CPU 401 of the control device 400 generates a force command value to be used in controlling the force of the robot 10, and controls the force of the robot 10 using the generated force command value, thereby manufacturing an article. Hereinafter, a method for manufacturing an article (information processing method) will be specifically described. The press-fitting work is part or all of a manufacturing process for manufacturing an article.

The operation panel 450 is also constituted by a computer. The operation panel 450 includes a CPU serving as a processor. In addition, the operation panel 450 includes storage devices such as a ROM and a RAM.

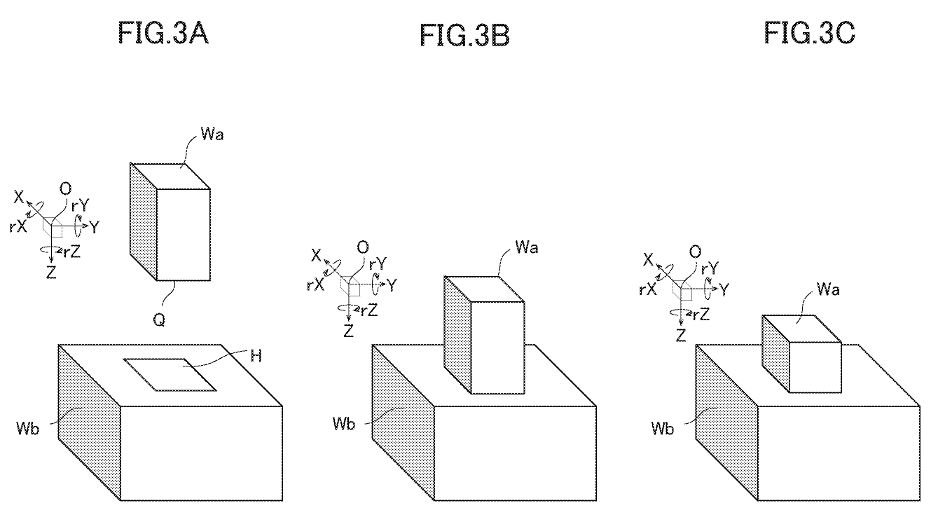

FIGS. 3A, 3B, and 3C are explanatory diagrams of the press-fitting work according to the first embodiment. In FIGS. 3A to 3C, for simplification of explanation, only movements of the workpiece Wa and the workpiece Wb are illustrated while the robot arm 100 and the end effector 200 are omitted.

FIG. 3A illustrates a state in which the workpiece Wa is moving to a press-fitting start position, FIG. 3B illustrates a state in which the workpiece Wa is in contact with the workpiece Wb, and FIG. 3C illustrates a state in which the workpiece Wa is pushed into the recess H of the workpiece Wb. In the press-fitting work, the operations illustrated in FIGS. 3A to 3C are sequentially performed.

Here, a coordinate system O is set on the end effector 200 of the robot 10, and in the present embodiment, on the workpiece Wa held by the end effector 200. The end effector 200 is an example of a predetermined portion. Since the coordinate system O moves in conjunction with the movement of the end effector 200, it can be said that the coordinate system O is set on the end effector 200.

The coordinate system O is a workpiece coordinate system based on the workpiece Wa, and the origin of the coordinate system O is a control point. The origin of the coordinate system O is, for example, the center of the distal end surface Q of the workpiece Wa, which is a tool center point (TCP). In the coordinate system O, three coordinate axes X, Y, and Z indicating three translation directions and three coordinate axes rX, rY, and rZ indicating three rotation directions are defined. The coordinate axis X, the coordinate axis Y, and the coordinate axis Z are axes orthogonal to each other.

The translation direction along the coordinate axis X is defined as an X direction. The translation direction along the coordinate axis Y is defined as a Y direction. The translation direction along the coordinate axis Z is defined as a Z direction. The rotation direction along the coordinate axis rX, that is, a rotation direction around the coordinate axis X, is defined as an rX direction. The rotation direction along the coordinate axis rY, that is, a rotation direction around the coordinate axis Y, is defined as an rY direction. The rotation direction along the coordinate axis rZ, that is, a rotation direction around the coordinate axis Z, is defined as an rZ direction. The force command value can be set for each of the coordinate axes X, Y, Z, rX, rY, and rZ, that is, for each of the X direction, the Y direction, the Z direction, the rX direction, the rY direction, and the rZ direction.

Here, for example, the X direction includes two directions (+X direction and -X direction) opposite to each other along the coordinate axis X. The +X direction indicates one of the two directions, and the -X direction indicates the other of the two directions. That is, the +X direction and the -X direction are directions opposite to each other in the +X direction. The same applies to the coordinate axes Y, Z, rX, rY, and rZ as well as the coordinate axis X.

In the first embodiment, the CPU 401 of the control device 400 generates a force command value in a target direction, among the X direction, the Y direction, the Z direction, the rX direction, the rY direction, and the rZ direction, and commands the servo control unit 470 with the generated force command value. The servo control unit 470 controls a force such as a contact force applied to the workpiece Wa according to the force command value with reference to the coordinate system O. Note that the coordinate system O only needs to be a coordinate system that moves in conjunction with the movement of the end effector 200, and the origin (control point) of the coordinate system O may be in contact with the end effector 200 or may be separated from the end effector 200.

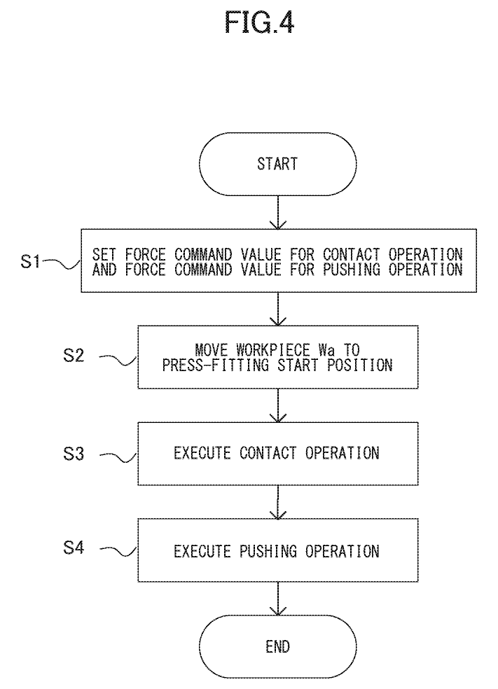

FIG. 4 is a flowchart illustrating the press-fitting work according to the first embodiment. For the force control in the press-fitting work, a plurality of operations are executed. In the first embodiment, two operations, that is, a contact operation of bringing the workpiece Wa into contact with the workpiece Wb and a pushing operation of pushing the workpiece Wa into the recess H of the workpiece Wb, are executed.

First, in step S1, the CPU 401 generates a force command value for force control when causing the robot 10 to execute the contact operation, and a force command value for force control when causing the robot 10 to execute the pushing operation, using the setting information 421 including the input information from the user.

Here, the setting of the setting information 421 used to generate the force command value for the contact operation and the force command value for the pushing operation will be described. Here, the setting refers to storing the setting information 421 in a storage device such as the HDD 404 in the first embodiment. Hereinafter, the force command value in the Z direction, among the six X direction, Y direction, Z direction, rX direction, rY direction, and rZ direction, will be described as an example.

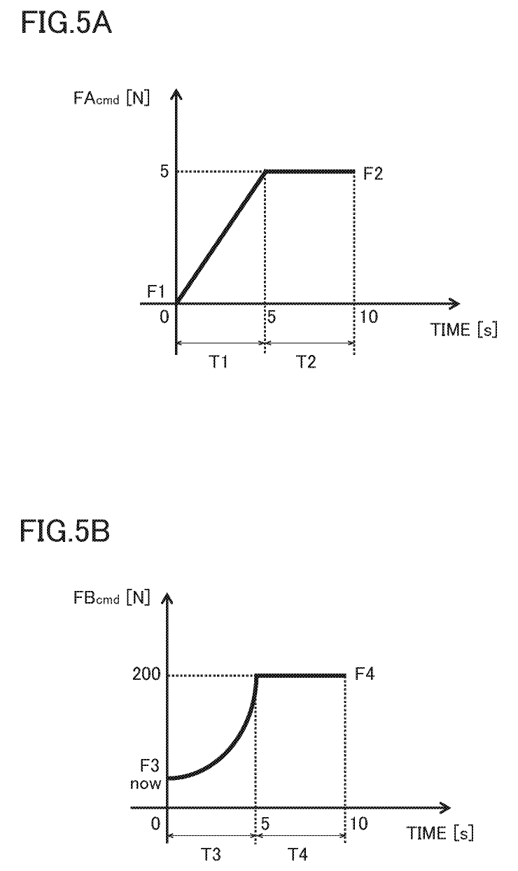

FIG. 5A is an explanatory diagram illustrating a change over time in force command value FA_{cmd} (N) in the Z direction (coordinate axis Z) related to the contact operation according to the first embodiment. The CPU 401 of the control device 400 acquires an initial value F1 and a target value F2 of the force command value FA_{cmd}. The initial value F1 is an example of a first value, and the target value F2 is an example of a second value. Here, the CPU 401 acquiring a value includes the CPU 401 receiving an input of a value from a user, the CPU 401 receiving a value from a device such as a sensor, and the CPU 401 obtaining a value based on data received from a device such as a sensor.

In addition, the CPU 401 receives, via the operation panel 450, an input made by the user regarding a manner of changing the force command value FA_{cmd} over time from the initial value F1 to the target value F2. The manner of changing the force command value FA_{cmd} over time from the initial value F1 to the target value F2 includes an interpolation method such as whether to perform linear interpolation or quadratic interpolation between the initial value F1 and the target value F2, a reaching time T1 until the force command value FA_{cmd} reaches the target value F2 from the initial value F1, and a standby time T2 during which the force command value FA_{cmd} is maintained at the target value F2 after the force command value FA_{cmd} reaches the target value F2. In the example of FIG. 5A, the initial value F1 is 0, the target value F2 is 5 N, the interpolation method is linear interpolation, and the reaching time T1 is 5 s.

The standby time T2 is a time for waiting until an external force acting on the workpiece Wa, that is, an external force acting on the robot 10, is stabilized. After the force command value FA_{cmd} reaches the target value F2, the force control execution time is extended by the length of the standby time T2. The force command value FA_{cmd} during the standby time T2 is maintained at the target value F2. In the example of FIG. 5A, the standby time T2 is 5 s.

These pieces of information, that is, the initial value F1, the target value F2, and the manner of changing the force command value FA_{cmd} over time from the initial value F1 to the target value F2 (including the interpolation method, the reaching time T1, and the standby time T2) are set as the setting information 421.

FIG. 5B is an explanatory diagram illustrating a change over time in force command value FB_{cmd} (N) in the Z direction related to the pushing operation according to the first embodiment. The CPU 401 of the control device 400 acquires an initial value F3 and a target value F4 of the force command value FB_{cmd}. The initial value F3 is an example of a first value, and the target value F4 is an example of a second value. The CPU 401 receives, via the operation panel 450, an input made by the user regarding the manner of changing the force command value FB_{cmd} over time from the initial value F3 to the target value F4.

The manner of changing the force command value FB_{cmd} over time from the initial value F3 to the target value F4 includes an interpolation method such as whether to perform linear interpolation or quadratic interpolation between the initial value F3 and the target value F4, a reaching time T3 until the force command value FB_{cmd} reaches the target value F4 from the initial value F3, and a standby time T4 during which the force command value FB_{cmd} is maintained at the target value F4 after the force command value FB_{cmd} reaches the target value F4. In the example of FIG. 5B, the initial value F3 is "now", the target value F4 is 200 N, the interpolation method is quadratic interpolation, and the reaching time T3 is 5 s.

The standby time T4 is a time for waiting until an external force acting on the workpiece Wa, that is, an external force acting on the robot 10, is stabilized. After the force command value FB_{cmd} reaches the target value F4, the force control execution time is extended by the length of the standby time T4. The force command value FB_{cmd} during the standby time T4 is maintained at the target value F4. In the example of FIG. 5B, the standby time T4 is 5 s.

Here, the initial value F3 (“now”) is set based on the external force acting on the end effector 200 of the robot 10 at a predetermined timing. The predetermined timing is a timing at or before the start of the force control using the force command value FB_{cmd} from the initial value F3 to the target value F4, and the initial value F3 is set to, for example, 5 N, which is the same as the target value F2. The external force acting on the end effector 200 of the robot 10 is obtained based on the torque values of the plurality of torque sensors 103 arranged at the plurality of joints of the robot arm 100, respectively. Note that the external force is not limited to being detected by the torque sensor 103, and may be detected by, for example, a six-axis force sensor provided in the robot 10.

These pieces of information, that is, the initial value F3, the target value F4, and the manner of changing the force command value FB_{cmd} over time from the initial value F3 to the target value F4 (including the interpolation method, the reaching time T3, and the standby time T4) are set as the setting information 421.

In step S1 of FIG. 4, the CPU 401 of the control device 400 generates a force command value FA_{cmd} from the initial value F1 to the target value F2 based on the initial value F1, the target value F2, and the manner of changing the force command value FA_{cmd} over time from the initial value F1 to the target value F2. In addition, in step S1 of FIG. 4, the CPU 401 of the control device 400 generates a force command value FB_{cmd} from the initial value F3 to the target value F4 based on the initial value F3, the target value F4, and the manner of changing the force command value FB_{cmd} over time from the initial value F3 to the target value F4.

Next, in step S2, the CPU 401 controls the robot 10 such that the workpiece Wa held by the robot 10 moves to the press-fitting start position. As illustrated in FIG. 3A, the press-fitting start position is a position above the recess H of the workpiece Wb. The press-fitting start position is, for example, a distance from the workpiece Wa to the recess H of the workpiece Wb in the Z direction of the coordinate system O, and is set arbitrarily (for example, 10 mm). Note that the teaching of the robot 10 for moving the workpiece Wa to the press-fitting start position may be online teaching performed using the operation panel 450 such that the actual workpiece Wa matches the workpiece Wb, or may be offline teaching performed from the design dimensions of the respective devices of the robot system 1000.

Next, in step S3, the CPU 401 commands the servo control unit 470 with the force command value FA_{cmd} generated based on the setting information 421, thereby causing the robot 10 to execute a contact operation to bring the workpiece Wa into contact with the workpiece Wb as illustrated in FIG. 3B.

Specifically, in step S3, the CPU 401 moves the workpiece Wa in the +Z direction, and brings the workpiece Wa into contact with the workpiece Wb as illustrated in FIG. 3B. At this time, the force command value FA_{cmd} gradually increases, suppressing the rapid acceleration of the robot 10, so that the workpiece Wa can be gently brought into contact with the workpiece Wb. When the output of the set force command value FA_{cmd} is completed, the contact operation performed under the force control ends.

Next, in step S4, the CPU 401 commands the servo control unit 470 with the force command value FB_{cmd} generated based on the setting information 421, thereby causing the robot 10 to execute a pushing operation to push the workpiece Wa into the workpiece Wb as illustrated in FIG. 3C.

Specifically, in step S4, the CPU 401 applies a load to the workpiece Wa in the +Z direction, and pushes the workpiece Wa into the workpiece Wb as illustrated in FIG. 3C. Since the force command value FB_{cmd} gradually increases, the overcurrent into the motor 101 and the damage to the robot 10 can be prevented. When the output of the set force command value FB_{cmd} is completed, the pushing operation performed under the force control ends.

Although the linear interpolation and the quadratic interpolation have been described as examples of the interpolation method, the interpolation method is not limited thereto. For example, the interpolation method may include a transfer function (low-pass filter) of a first-order lag system.

As described above, a plurality of operations are executed in the force control, and in the first embodiment, two operations, that is, a contact operation and a pushing operation, are executed. A setting screen used for setting each of the plurality of operations is displayed, for example, on the display 451 of the operation panel 450 illustrated in FIG. 1. The setting of the plurality of operations is performed for each operation on different setting screens.

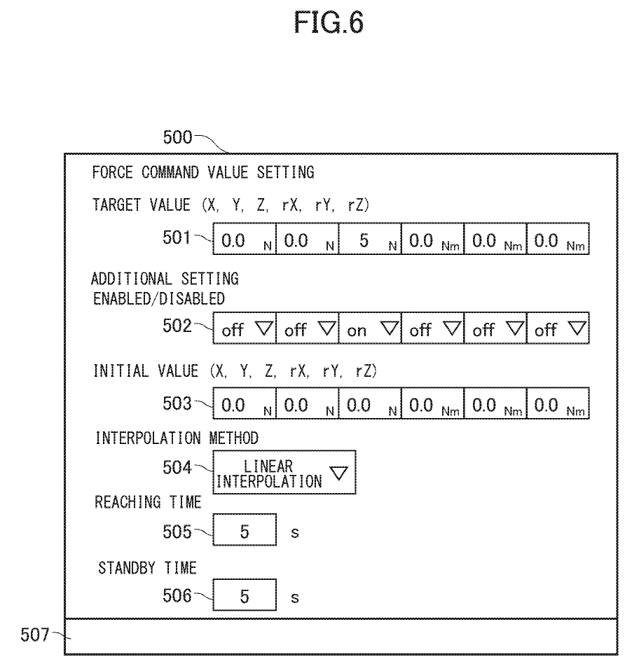

FIG. 6 is an explanatory diagram of a setting screen 500 according to the first embodiment. The setting screen 500 is an example of a user interface for receiving a user’s input. The CPU 401 displays the setting screen 500, for example, on the display 451 of the operation panel 450 illustrated in FIG. 1. The setting screen 500 is a user interface image that allows the user to perform an input operation. The setting screen 500 is a screen for setting the force command value FA_{cmd} related to the contact operation.

The setting screen 500 includes a setting box 501, a setting box 502, a setting box 503, a setting box 504, a setting box 505, a setting box 506, and a warning display area 507.

The setting box 501 is a box for receiving a user’s input regarding the target value F2 of the force command value FA_{cmd} in each of the plurality of directions, that is, the X direction, the Y direction, the Z direction, the rX direction, the rY direction, and the rZ direction. In the setting box 501, the input of the target value F2 is received for each coordinate axis.

The setting box 502 is a box for receiving a user’s selection as to whether to generate a force command value FA_{cmd} based on the manner of changing the force command value FA_{cmd} over time from the initial value F1 to the target value F2 for each of the X direction, the Y direction, the Z direction, the rX direction, the rY direction, and the rZ direction. In the setting box 502, for example, two options are displayed in a pull-down manner. The setting box 502 is configured such that the user can select one of the two options displayed in a pull-down manner. The pull-down menu includes "on", which indicates generating a force command value FA_{cmd} that changes gradually, and "off", which indicates not generating a force command value FA_{cmd} that changes gradually. That is, by selecting "on" or "off", the user can input a selection as to whether to perform an additional setting for the manner of changing the force command value over time.

When "on" is selected, information input in the setting boxes 503 to 506 is applied to the generation of the force command value FA_{cmd}. When "off" is selected, a stepwise target value is set.

The CPU 401 receives, through the setting box 502, a user's selection as to whether to generate a force command value FA_{cmd} based on the manner of changing the force command value FA_{cmd} over time for each of the X direction, the Y direction, the Z direction, the rX direction, the rY direction, and the rZ direction of the end effector 200 of the robot 10.

The setting box 503 is a box for receiving a user’s input regarding the initial value F1 of the force command value FA_{cmd} for each of the X direction, the Y direction, the Z direction, the rX direction, the rY direction, and the rZ direction. In the setting box 503, the input of the initial value F1 is received for each coordinate axis.

The setting boxes 504 to 506 are boxes for receiving user’s inputs regarding the manner of changing the force command value FA_{cmd} over time from the initial value F1 to the target value F2.

In the setting box 504, for example, a plurality of options are displayed in a pull-down manner. The setting box 504 is configured such that the user can select one of the plurality of options displayed in a pull-down manner. The pull-down menu includes a plurality of interpolation methods such as "linear interpolation" for performing linear interpolation between the initial value F1 and the target value F2 and "quadratic interpolation" for performing quadratic interpolation between the initial value F1 and the target value F2.

The setting box 505 is a box for receiving a user’s input regarding the reaching time T1 until the force command value FA_{cmd} reaches the target value F2 from the initial value F1.

The setting box 506 is a box for receiving a user's input regarding the standby time T2 during which the force command value FA_{cmd} is maintained at the target value F2 after the force command value FA_{cmd} reaches the target value F2.

As described above, the CPU 401 is configured to receive an input regarding the manner of changing the force command value FA_{cmd} over time from the initial value F1 to the target value F2 through the setting box 504, the setting box 505, and the setting box 506. Note that the setting box 504, the setting box 505, and the setting box 506 may be configured to receive an input for each coordinate axis. The coordinate axes for the force command values specified in the setting box 501 and the setting box 503 are X, Y, Z, rX, rY, and rZ, and may be coordinate axes in any coordinate system, but in the present embodiment, the coordinate system O is used as a reference.

In the example of FIG. 6, in the setting box 503, 0 is input for the initial values F1 in the X direction, the Y direction, the Z direction, the rX direction, the rY direction, and the rZ direction. In the example of FIG. 6, in the setting box 501, 5 N is input for the target value F2 in the Z direction, and 0 is input for the target values F2 in the directions other than the Z direction. In the example of FIG. 6, “on” is selected for the Z direction, and “off” is selected for the directions other than the Z direction. Therefore, a force command value FA_{cmd} that gradually changes over time from the initial value F1 to the target value F2 in the Z direction is generated.

In the example of FIG. 6, "linear interpolation" for performing linear interpolation between the initial value F1 and the target value F2 is selected in the setting box 504, 5 s is input as the reaching time T1 in the setting box 505, and 5 s is input as the standby time T2 in the setting box 506.

That is, the Z direction is selected as a target for which the force command value FA_{cmd} is changed over time between the initial value F1 and the target value F2, and linear interpolation is performed in the Z direction from the initial value F1 (=0) to the target value F2 (=5 N) so that the reaching time T1 becomes 5 s, thereby generating a force command value FA_{cmd} from the initial value F1 (=0) to the target value F2 (=5 N) as illustrated in FIG. 5A.

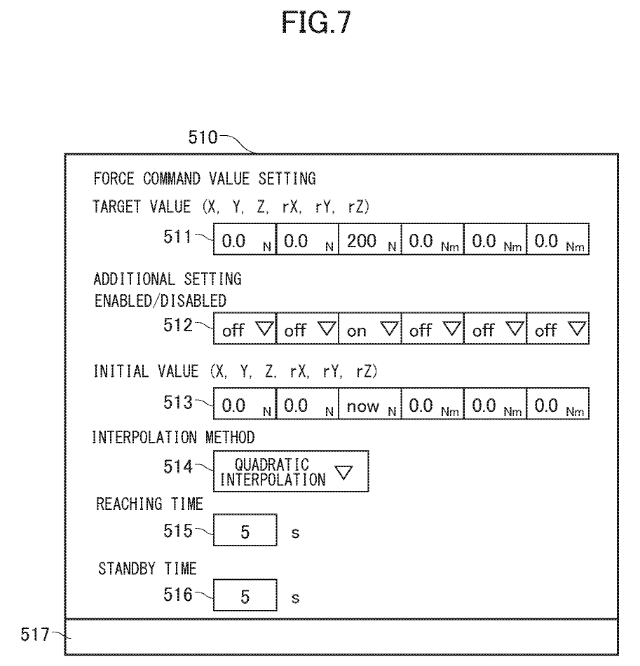

FIG. 7 is an explanatory diagram of a setting screen 510 according to the first embodiment. The setting screen 510 is an example of a user interface for receiving a user’s input. The CPU 401 displays the setting screen 510, for example, on the display 451 of the operation panel 450 illustrated in FIG. 1. The setting screen 510 is a user interface image that allows the user to perform an input operation. The setting screen 510 is a screen for setting the force command value FB_{cmd} related to the pushing operation.

The setting screen 510 includes a setting box 511, a setting box 512, a setting box 513, a setting box 514, a setting box 515, a setting box 516, and a warning display area 517.

The setting box 511 is a box for receiving a user’s input regarding the target value F4 of the force command value FB_{cmd} for each of the X direction, the Y direction, the Z direction, the rX direction, the rY direction, and the rZ direction.

The setting box 512 is a box for receiving a user’s selection as to whether to generate a force command value FB_{cmd} based on the manner of changing the force command value FB_{cmd} over time from the initial value F3 to the target value F4 for each of the X direction, the Y direction, the Z direction, the rX direction, the rY direction, and the rZ direction. In the setting box 512, for example, two options are displayed in a pull-down manner. The setting box 512 is configured such that the user can select one of the two options displayed in a pull-down manner. The pull-down menu includes "on", which indicates generating a force command value FB_{cmd} that changes gradually, and "off", which indicates not generating a force command value FB_{cmd} that changes gradually. That is, by selecting "on" or "off", the user can input a selection as to whether to perform an additional setting for the manner of changing the force command value over time.

When "on" is selected, information input in the setting boxes 513 to 516 is applied to the generation of the force command value FB_{cmd}. When "off" is selected, a stepwise target value is set.

The CPU 401 receives, through the setting box 512, a user's selection as to whether to generate a force command value FB_{cmd} based on the manner of changing the force command value FB_{cmd} over time for each of the X direction, the Y direction, the Z direction, the rX direction, the rY direction, and the rZ direction of the end effector 200 of the robot 10.

The setting box 513 is a box for receiving a user’s input regarding the initial value F3 of the force command value FB_{cmd} for each of the X direction, the Y direction, the Z direction, the rX direction, the rY direction, and the rZ direction.

The setting boxes 514 to 516 are boxes for receiving user’s inputs regarding the manner of changing the force command value FB_{cmd} over time from the initial value F3 to the target value F4.

In the setting box 514, for example, a plurality of options are displayed in a pull-down manner. The setting box 514 is configured such that the user can select one of the plurality of options displayed in a pull-down manner. The pull-down menu includes a plurality of interpolation methods such as "linear interpolation" for performing linear interpolation between the initial value F3 and the target value F4 and "quadratic interpolation" for performing quadratic interpolation between the initial value F3 and the target value F4.

The setting box 515 is a box for receiving a user’s input regarding the reaching time T3 until the force command value FB_{cmd} reaches the target value F4 from the initial value F3.

The setting box 516 is a box for receiving a user's input regarding the standby time T4 during which the force command value FB_{cmd} is maintained at the target value F4 after the force command value FB_{cmd} reaches the target value F4.

As described above, the CPU 401 is configured to receive an input regarding the manner of changing the force command value FB_{cmd} over time from the initial value F3 to the target value F4 through the setting box 514, the setting box 515, and the setting box 516. Note that the setting box 514, the setting box 515, and the setting box 516 may be configured to receive an input for each coordinate axis. The coordinate axes for the force command values specified in the setting box 511 and the setting box 513 are X, Y, Z, rX, rY, and rZ, and may be coordinate axes in any coordinate system, but in the present embodiment, the coordinate system O is used as a reference.

In the example of FIG. 7, in the setting box 513, 0 is input for the initial values F3 in the directions other than the Z direction. In the example of FIG. 7, in the setting box 511, 200 N is input for the target value F4 in the Z direction, and 0 is input for the target values F4 in the directions other than the Z direction. In the example of FIG. 7, “on” is selected for the Z direction, and “off” is selected for the directions other than the Z direction. Therefore, a force command value FB_{cmd} that gradually changes over time from the initial value F3 to the target value F4 in the Z direction is generated.

Furthermore, in the example of FIG. 7, in the setting box 513, “now” is input, instead of a numerical value, for the initial value F3 in the Z direction. When “now” is input, a value of an external force in the coordinate system O applied to the end effector 200 at or before the start of the force control in the pushing operation is set as the initial value F3. The time before the start of the force control may refer to a time immediately before the start of the force control.

In the example of FIG. 7, "quadratic interpolation" for performing quadratic interpolation between the initial value F3 and the target value F4 is selected in the setting box 514, 5 s is input as the reaching time T3 in the setting box 515, and 5 s is input as the standby time T4 in the setting box 516.

That is, the Z direction is selected as a target for which the force command value FB_{cmd} is changed over time between the initial value F3 and the target value F4, and quadratic interpolation is performed in the Z direction from the initial value F3 (=F2) to the target value F4 (=200 N) so that the reaching time T3 becomes 5 s, thereby generating a force command value FB_{cmd} from the initial value F3 (=5 N) to the target value F4 (=200 N) as illustrated in FIG. 5B.

By inputting “now” in the setting box 513, in a case where force control is executed from a state in which an external force acts on the robot 10, such as a state in which the workpiece Wa is in contact with the workpiece Wb, the change in the load applied to the robot 10 is reduced, enabling stable force control, so that the overcurrent into the motor 101 and the damage to the robot 10 can be prevented. Note that, in the setting box 503 illustrated in FIG. 6, similarly to the setting box 513, “now” can also be input.

In the first embodiment, the CPU 401 receives an input of a data set including the initial value F1, the target value F2, and the manner of changing the force command value FA_{cmd} over time from the initial value F1 to the target value F2 via the setting screen 500 corresponding to the contact operation. In the first embodiment, the CPU 401 also receives an input of a data set including the initial value F3, the target value F4, and the manner of changing the force command value FB_{cmd} over time from the initial value F3 to the target value F4 via the setting screen 510 corresponding to the pushing operation. In this manner, the CPU 401 receives inputs of two data sets. Although the case where the plurality of operations include two operations has been described as an example, the plurality of operations is not limited thereto, and may include three or more operations. At this time, the CPU 401 only needs to be configured to receive inputs of three or more data sets corresponding to the three or more operations via three or more setting screens.

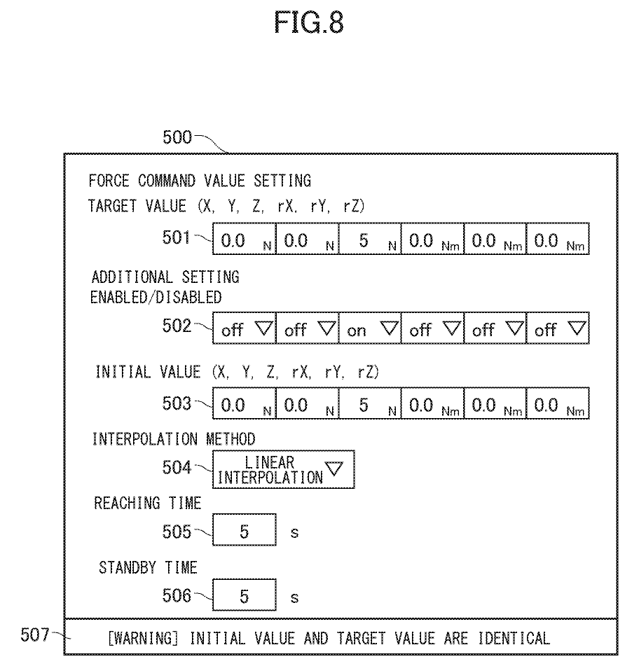

Here, in the first embodiment, the CPU 401 issues a warning in a case where an inexecutable value is input to the robot 10 on the setting screen 500 by the user. FIG. 8 is an explanatory diagram of a setting screen 500 according to the first embodiment. As an example of a warning, the CPU 401 displays a warning message in the warning display area 507 as illustrated in FIG. 8.

As illustrated in FIG. 8, for the coordinate axis Z for which "on" is selected in the setting box 502, the initial value F1 input in the setting box 503 and the target value F2 input in the setting box 501 are identical, which means that it is impossible to gradually increase or decrease the force command value FA_{cmd}. That is, the inexecutable value includes the target value F2 being the same as the initial value F1. In this case, the CPU 401 determines that a value that cannot be executed by the robot 10 has been input, and issues a warning to the user by displaying the fact in the warning display area 507.

Note that a warning other than that described above may be displayed in the warning display area 507. For example, in a case where the reaching time T1 input in the setting box 505 is 0 or less, or in a case where the standby time T2 input in the setting box 506 is less than 0, the CPU 401 may display the fact in the warning display area 507.

Although the warning display area 507 of the setting screen 500 has been described as an example, a warning may also be issued in the warning display area 517 of the setting screen 510 similarly to the warning display area 507.

Furthermore, the warning to the user is not limited to being given by an image (visual information) such as text, and may also be given by, for example, sound (auditory information), vibration (tactile information), or the like.

As described above, according to the first embodiment, by using the above-described user interfaces, the user can easily set the setting information 421 used to generate complicated force command values FA_{cmd} and FB_{cmd} that gradually increase or decrease. In this manner, the first embodiment provides a technique advantageous in setting the setting information 421 used to generate the force command values FA_{cmd} and FB_{cmd}.

### Second Embodiment

The second embodiment will be described. Hereinafter, unless otherwise specified, elements denoted by the same reference signs as those in the first embodiment have substantially the same configurations and functions as those described in the first embodiment, and differences from the first embodiment will be mainly described.

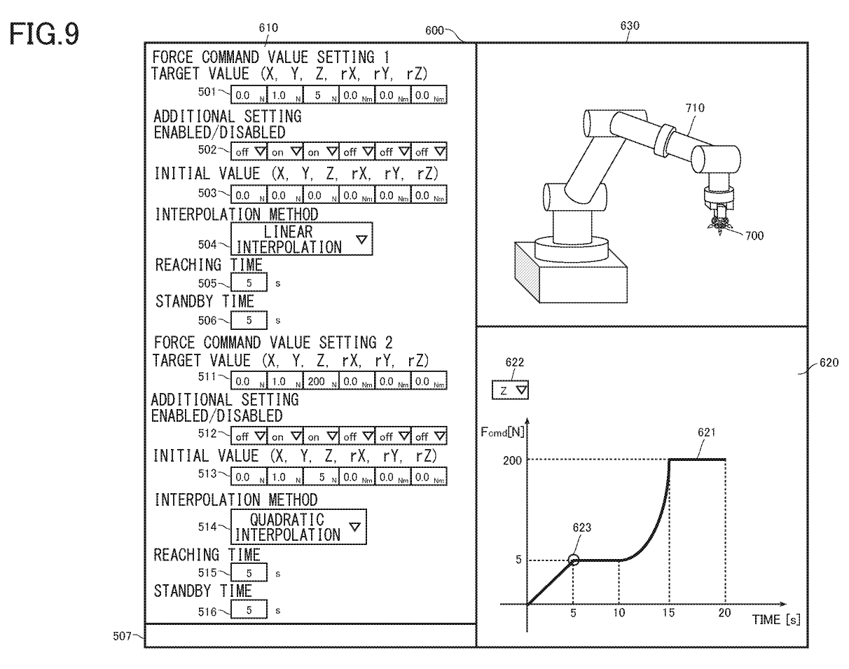

FIG. 9 is an explanatory diagram of a main screen 600 according to the second embodiment. The main screen 600 is an example of a user interface, and is displayed, for example, on the display 451 of the operation panel 450 illustrated in FIG. 1. The main screen 600 is a user interface image that allows the user to perform an input operation.

The main screen 600 includes a setting screen 610, a display screen 620, and an operation screen 630.

In the first embodiment, a case where a plurality of data sets corresponding to a plurality of operations are input through a plurality of setting screens has been described as an example, but the input of the plurality of data sets is not limited thereto. In the second embodiment, a plurality of data sets corresponding to a plurality of operations are input through one setting screen 610. That is, in the first embodiment, the user interfaces corresponding to the contact operation and the pushing operation are divided into the setting screen 500 illustrated in FIG. 6 and the setting screen 510 illustrated in FIG. 7, whereas in the second embodiment, the user interfaces corresponding to the contact operation and the pushing operation are collected in the setting screen 610 illustrated in FIG. 9.

In FIG. 9, the same items as those in the first embodiment are denoted by the same reference signs, and description thereof will be omitted. In the second embodiment, since the robot 10 executes two operations consecutively, a force command value F_{cmd} obtained by combining two force command values FA_{cmd} and FB_{cmd} is set using one setting screen 610.

The CPU 401 sets input information input to the setting screen 610 as the setting information 421. Then, the CPU 401 generates a force command value F_{cmd} based on the setting information 421. The CPU 401 displays the force command value F_{cmd} that varies over time on the display screen 620 using a graph (waveform) 621. In this manner, by displaying the force command value F_{cmd} using the graph (waveform) 621, the user can visually recognize the force command value F_{cmd}, making it easier to set the setting information 421 used to generate the force command value F_{cmd}. The CPU 401 may display the force command value F_{cmd} on the display 451 as a numerical value instead of the graph 621.

In the second embodiment, the plurality of force command values FA_{cmd} and FB_{cmd} are consecutively displayed as the force command value F_{cmd} on the display screen 620 using the graph 621. When at least one of the initial value F1, the target value F2, the interpolation method between the initial value F1 and the target value F2, the reaching time T1, the standby time T2, the initial value F3, the target value F4, the interpolation method between the initial value F3 and the target value F4, the reaching time T3, and the standby time T4 is changed on the setting screen 610, the CPU 401 updates the force command value F_{cmd} according to the change and updates the graph 621 displayed on the display screen 620.

Here, the display screen 620 includes a selection box 622. In the selection box 622, the CPU 401 receives a user's selection from among the X direction, the Y direction, the Z direction, the rX direction, the rY direction, and the rZ direction of the coordinate system O that moves in conjunction with the end effector 200 of the robot 10. In the example of FIG. 9, the Z direction is selected by the user. The graph 621 displayed on the display screen 620 is a graph for the command value in the Z direction selected by the user. In this manner, the user can check the command value in the direction selected from among the plurality of directions using the graph.

As described above, the graph to be displayed may be selected through the selection box 622. However, in the second embodiment, the CPU 401 is configured to display an operation handle 700 that can be operated by the user on the operation screen 630 of the main screen 600, and receive a user’s selection from among the X direction, the Y direction, the Z direction, the rX direction, the rY direction, and the rZ direction using the operation handle 700.

In the second embodiment, the CPU 401 displays a robot image 710 representing a virtual robot corresponding to the robot 10, together with the operation handle 700, on the operation screen 630 of the main screen 600. The operation handle 700 may be displayed at a position corresponding to a control point of the robot 10.

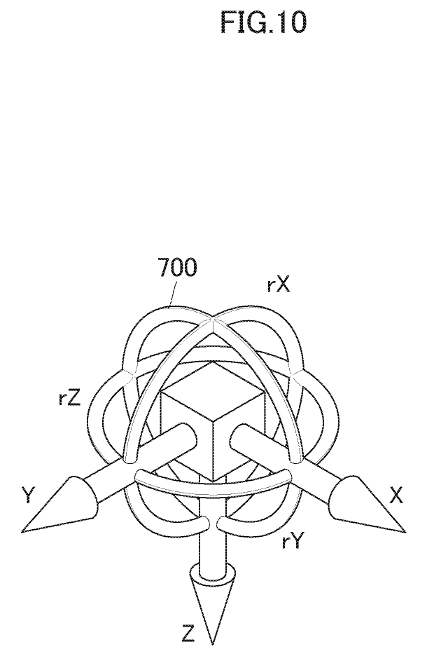

FIG. 10 is an explanatory diagram of the operation handle 700 according to the second embodiment. The operation handle 700 includes images corresponding to the coordinate axes X, Y, Z, rX, rY, and rZ. When the user selects an image corresponding to a coordinate axis, a graph corresponding to the selected coordinate axis is displayed on the display screen 620. For example, when the user selects an image corresponding to the coordinate axis Z on the operation handle 700, the graph 621 corresponding to the selected coordinate axis Z is displayed on the display screen 620.

In the second embodiment, the CPU 401 receives a user’s operation of changing the graph 621. Then, the CPU 401 changes the force command value F_{cmd} according to the user’s operation of changing the graph 621. For example, the CPU 401 displays an operation unit 623 that can be operated by the user on the graph 621, and changes the initial value F1, the target value F2, the interpolation method between the initial value F1 and the target value F2, the reaching time T1, the standby time T2, the initial value F3, the target value F4, the interpolation method between the initial value F3 and the target value F4, the reaching time T3, or the standby time T4, following a user’s operation of the operation unit 623.

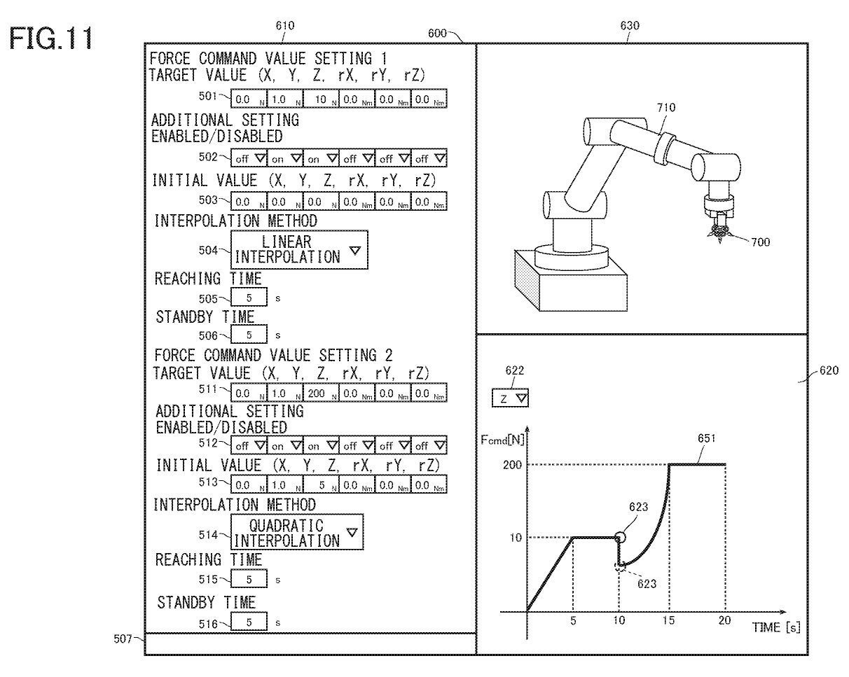

FIG. 11 is an explanatory diagram of a main screen 600 according to the second embodiment. When the user selects a position on the graph 621 displayed on the display screen 620 of the main screen 600, the CPU 401 displays the operation unit 623 indicated by a broken line at the selected position. In this state, when the operation unit 623 is dragged in the vertical direction, the CPU 401 deforms the graph (waveform) 621 according to the operation of the operation unit 623, and displays the deformed graph (waveform) 651 on the operation unit 623.

Then, the CPU 401 changes the initial value F1, the target value F2, the interpolation method between the initial value F1 and the target value F2, the reaching time T1, the standby time T2, the initial value F3, the target value F4, the interpolation method between the initial value F3 and the target value F4, the reaching time T3, or the standby time T4, following the user’s operation of the operation unit 623, that is, according to the deformed graph 651.

As the force command value F_{cmd} is changed, the display of the corresponding setting box among the plurality of setting boxes 501 to 506 and 511 to 516 on the setting screen 640 is also automatically changed. In the example of FIG. 11, the target value F2 in the setting box 501 is changed from 5 N to 10 N.

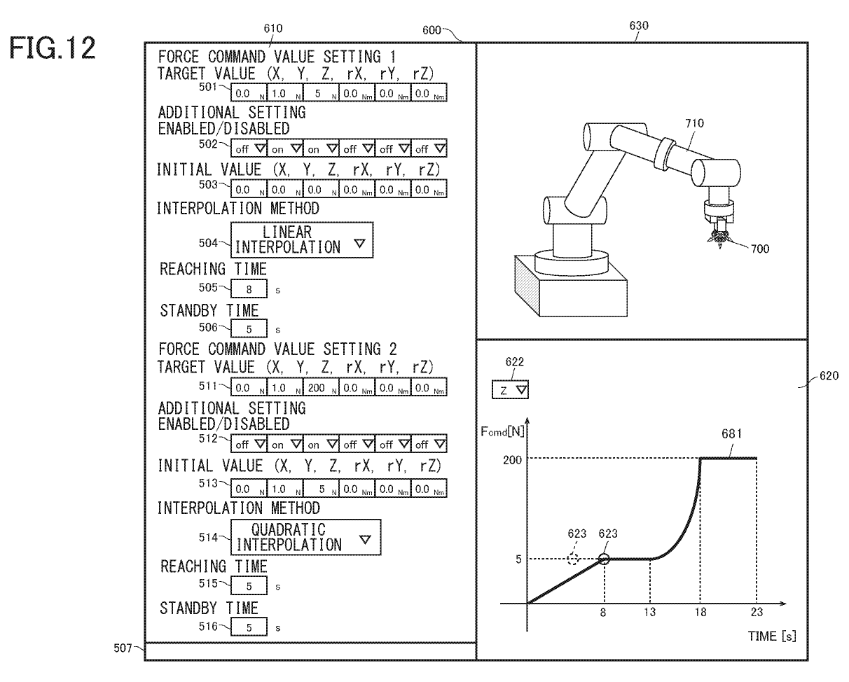

FIG. 12 is an explanatory diagram of a main screen 600 according to the second embodiment. When the user selects a position on the graph 621 displayed on the display screen 620 of the main screen 600, the CPU 401 displays the operation unit 623 indicated by a broken line at the selected position. In this state, when the operation unit 623 is dragged in the horizontal direction, the CPU 401 deforms the graph (waveform) 621 according to the operation of the operation unit 623, and displays the deformed graph (waveform) 681 on the operation unit 623.

Then, the CPU 401 changes the initial value F1, the target value F2, the interpolation method between the initial value F1 and the target value F2, the reaching time T1, the standby time T2, the initial value F3, the target value F4, the interpolation method between the initial value F3 and the target value F4, the reaching time T3, or the standby time T4, following the user’s operation of the operation unit 623, that is, according to the deformed graph 681.

As the force command value F_{cmd} is changed, the display of the corresponding setting box among the plurality of setting boxes 501 to 506 and 511 to 516 on the setting screen 640 is also automatically changed. In the example of FIG. 12, the reaching time T1 in the setting box 505 is changed from 5 s to 8 s.

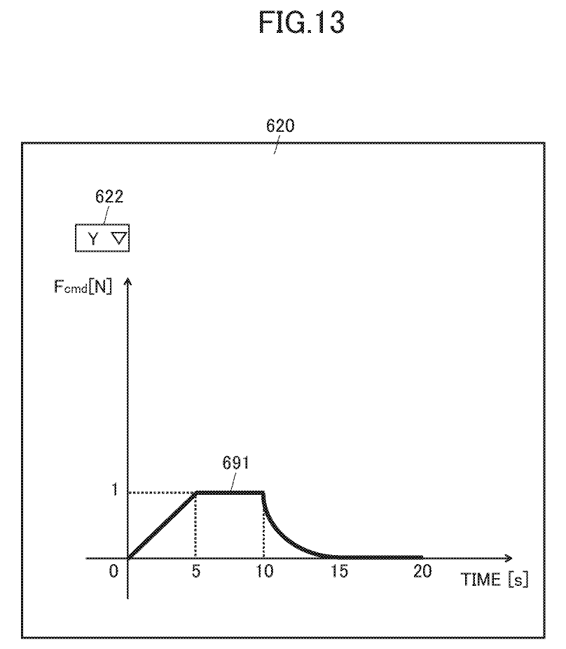

FIG. 13 is an explanatory diagram of the display screen 620 according to the second embodiment. When the coordinate axis Y is selected by the selection box 622 or the operation handle 700 on the display screen 620, the CPU 401 displays a graph (waveform) 691 for the force command value in the coordinate axis Y on the display screen 620. When the coordinate axis Y is selected by the operation handle 700, the coordinate axis selected in the selection box 622 is automatically changed to the coordinate axis Y.

As described above, according to the second embodiment, by using the above-described user interface, the user can more easily set the setting information 421 used to generate a complicated force command value F_{cmd} that gradually increases or decreases. In this manner, the second embodiment provides a technique advantageous in setting the setting information 421 used to generate the force command value F_{cmd}.

### Other Modifications

In the above-described embodiments, the manner of changing the command value with respect to time has been described as an example, but the manner of changing the command value is not limited thereto. For example, the user may set a manner of changing the command value with respect to position. In the graphs on the display screens 620 of FIGS. 9 and 11, the horizontal axis represents the position to which the predetermined portion of the robot arm 100 moves. Then, in FIGS. 9 and 11, the setting box 505 and the setting box 515, which are boxes for setting reaching times, are used as boxes for setting reaching positions. Similarly, in FIGS. 9 and 11, the setting box 506 and the setting box 516, which are boxes for setting standby times, are used as boxes for setting standby positions. By doing so, the user can set the manner of changing the command value with respect to the position to which the predetermined portion of the robot arm 100 moves.

In addition, for example, the user may set a manner of changing the command value with respect to the process executed by the robot arm 100. In the graphs on the display screens 620 of FIGS. 9 and 11, the horizontal axis represents the process executed by the robot arm 100. In the horizontal axis, processes, such as process 1, process 2, and process 3, are displayed with their ranges. Then, in FIGS. 9 and 11, the setting box 505 and the setting box 515, which are boxes for setting reaching times, are used as boxes for setting reaching processes. Similarly, in FIGS. 9 and 11, the setting box 506 and the setting box 516, which are boxes for setting standby times, are used as boxes for setting standby processes. By doing so, the user can set the manner of changing the command value with respect to the process executed by the robot arm 100.

In addition, for example, the user may set a manner of changing the command value with respect to the number of times the specific operation is executed by the robot arm 100. In the graphs on the display screens 620 of FIGS. 9 and 11, the horizontal axis represents the number of times the specific operation is executed by the robot arm 100. In the horizontal axis, the number of times, such as first time, second time, and third time, are displayed with their ranges. Then, in FIGS. 9 and 11, the setting box 505 and the setting box 515, which are boxes for setting reaching times, are used as boxes for setting the number of times of reaching. Similarly, in FIGS. 9 and 11, the setting box 506 and the setting box 516, which are boxes for setting standby times, are used as boxes for setting the number of times of standby. By doing so, the user can set the manner of changing the command value with respect to the number of times the specific operation is executed by the robot arm 100.

In addition, for example, the user may set a manner of changing the command value with respect to the speed of the predetermined portion of the robot arm 100. In the graphs on the display screens 620 of FIGS. 9 and 11, the horizontal axis represents the speed of the predetermined portion of the robot arm 100 during movement. Then, in FIGS. 9 and 11, the setting box 505 and the setting box 515, which are boxes for setting reaching times, are used as boxes for setting reaching speeds. Similarly, in FIGS. 9 and 11, the setting box 506 and the setting box 516, which are boxes for setting standby times, are used as boxes for setting standby speeds. By doing so, the user can set the manner of changing the command value with respect to the speed of the predetermined portion of the robot arm 100 during movement. As described above, when setting the manner of changing the command value, various items can be set as parameters for the horizontal axis (the reference axis for setting the manner of changing the command value). Note that, the manner of changing the command value from the first value to the second value may also be expressed as a way of changing the command value from the first value to the second value. Further, the manner of changing the command value from the first value to the second value may be expressed as a transition profile of the command value from the first value to the second value. Typically, the transition profile is a time-series profile of the command value.

The present disclosure is not limited to the embodiments described above, and many modifications can be made within the technical spirit of the present disclosure. In addition, the effects described in the present embodiment merely enumerate the most suitable effects, and the present disclosure is not limited thereto. In addition, at least two of the plurality of embodiments and the plurality of modifications described above may be combined.

In the above-described embodiments, the robot arm 100 has six joints, but the number of joints of the robot arm 100 is not limited thereto, and the robot arm 100 only needs to have a plurality of joints. Furthermore, in the above-described embodiments, the robot arm 100 is a vertically articulated robot arm, but the type of robot arm 100 is not limited thereto. The robot arm 100 may be any of the various types of robot arms such as a horizontally articulated robot arm, a parallel-link robot arm, and a Cartesian robot.

Furthermore, in the above-described embodiments, the CPU 401 of the control device 400 that controls the robot 10 is configured to execute the above-described information processing method, but the execution of the above-described information processing method is not limited thereto, and the above-described information processing method may be executed by an information processing apparatus (computer) other than the control device 400, for example, the operation panel 450. Furthermore, the above-described information processing method may be executed in a distributed manner by a plurality of information processing apparatuses (computers).

In addition, the present disclosure is applicable to a machine capable of automatically performing an operation of expansion/contraction, bending/stretching, vertical movement, horizontal movement, turning, or a combination thereof based on information in the storage device provided in the control device.

As described above, according to the present disclosure, there is provided a technique advantageous in setting information to be used in generating a command value.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-055354, filed Mar. 28, 2025, which is hereby incorporated by reference herein in its entirety.

What is claimed is:

1. An information processing method for generating a command value to be used in controlling a force of a robot, the information processing method comprising:
acquiring a first value and a second value for the command value; and
receiving, from a user, a manner of changing the command value from the first value to the second value.

2. The information processing method according to claim 1, further comprising:
generating the command value from the first value to the second value based on the first value, the second value, and the manner of changing the command value.

3. The information processing method according to claim 1, wherein
the first value and the second value are received from the user.

4. The information processing method according to claim 1, further comprising:
receiving a selection from the user as to whether to generate the command value based on the manner of changing the command value for each of a plurality of directions in a predetermined portion of the robot.

5. The information processing method according to claim 4, wherein
the plurality of directions include three translation directions and three rotation directions.

6. The information processing method according to claim 1, further comprising:
setting the first value based on an external force acting on the robot at a predetermined timing.

7. The information processing method according to claim 6, wherein
the predetermined timing is a timing at or before which the control of the force corresponding to the command value from the first value to the second value is started.

8. The information processing method according to claim 1, wherein
the manner of changing the command value includes a reaching time until the command value reaches the second value from the first value.

9. The information processing method according to claim 1, wherein
the manner of changing the command value includes a standby time during which the command value is maintained at the second value after the command value reaches the second value.

10. The information processing method according to claim 1, further comprising:
issuing a warning in a case where an inexecutable value is input from the user to the robot.

11. The information processing method according to claim 10, wherein
the inexecutable value includes the second value being the same value as the first value.

12. The information processing method according to claim 1, wherein
a plurality of data sets input by the user are received, and
each of the plurality of data sets includes the first value, the second value, and the manner of changing the command value.

13. The information processing method according to claim 2, further comprising:
displaying the generated command value on a display unit using a graph.

14. The information processing method according to claim 2, further comprising:
displaying, on a display unit, a user interface for receiving an input from the user;
displaying the generated command value on the user interface using a graph;
receiving an operation of changing the graph from the user; and
changing the generated command value according to the operation.

15. The information processing method according to claim 14, further comprising:
receiving, on the user interface, a selection of a direction from the user from among a plurality of directions in a predetermined portion of the robot,
wherein the graph displayed on the user interface is a graph for the command value in the direction selected by the user from among the plurality of directions.

16. The information processing method according to claim 15, further comprising:
displaying an operation handle operable by the user on the user interface,
wherein the selection is received from the user from among the plurality of directions using the operation handle.

17. An information processing apparatus comprising a processor configured to generate a command value to be used in controlling a force of a robot,
wherein the processor is configured to:
acquire a first value and a second value for the command value; and
receive, from a user, a manner of changing the command value from the first value to the second value.

18. The robot controlled using the command value generated by the information processing method according to claim 1.

19. A method for manufacturing an article, the method comprising:
controlling the force of the robot using the command value generated by the information processing method according to claim 1.

20. A non-transitory computer-readable recording medium storing a program for causing a computer to execute the information processing method according to claim 1.
